(19) United States
(12) Patent Application Publication
(10) Pub. No.: US 2015/0332416 A1
(43) Pub. Date: Nov. 19, 2015

(54) INTERACTIONS IN SOCIAL NETWORKING SERVICES

(71) Applicants: Shimrit Ben-Yair, Sunnyvale, CA (US); Jonathan Terleski, Mountain View, CA (US); Ray Jiunn-An Su, Sunnyvale, CA (US)

(72) Inventors: Shimrit Ben-Yair, Sunnyvale, CA (US); Jonathan Terleski, Mountain View, CA (US); Ray Jiunn-An Su, Sunnyvale, CA (US)

(73) Assignee: GOOGLE INC., Mountain View, CA (US)

(21) Appl. No.: 13/527,164

(22) Filed: Jun. 19, 2012

Related U.S. Application Data
(60) Provisional application No. 61/499,089, filed on Jun. 20, 2011.

(51) Int. Cl. G06Q 50/00; G06Q 10/00; G06F 3/01

(52) U.S. Cl. CPC G06Q 50/01; G06Q 10/00

(57) ABSTRACT

Methods, systems, and apparatus, including computer programs encoded on a computer storage medium, for receiving, from a author user, a post data set associated with a post in a social networking service, the post data set including distribution data, the distribution data indicating one or more recipient users to which the first post is to be distributed, determining that at least one recipient user of the one or more recipient users is a non-direct intended recipient, the non-direct intended recipient not being a contact of the author user within the social networking service, receiving a social affinity score, the social affinity score indicating a strength of a relationship between the author user and the non-direct intended recipient, determining that the post is to be distributed to the non-direct intended recipient at least partially based on the social affinity score, and distributing the post to the non-direct intended recipient.

### CROSS-REFERENCE TO RELATED APPLICATIONS

This application claims priority to U.S. App. No. 61/499,089, filed Jun. 20, 2011, the disclosure of which is expressly incorporated herein by reference in its entirety.

### TECHNICAL FIELD

This specification generally relates to computer software systems and methods, in particular, systems and methods for managing social circles in a social networking service.

### BACKGROUND

Computers and mobile devices, such as cellular phones and personal digital assistants, have become increasingly interconnected due to the widespread availability of wired and wireless connections to communications networks such as the Internet. Even in the earliest days of the ARPANET, users took advantage of such interconnectivity to communicate with one another through early forms of email. As email grew in availability and popularity, email “lists” became a popular tool for broadcasting messages to predefined groups of recipients.

In the 1980's, Internet based “newsgroups” emerged in which users could read and respond to discussion threads revolving around a wide variety of predefined categories. Newsgroups are generally readable and updatable by anyone with the equipment to access them, since access to newsgroups is generally not restricted on a per-newsgroup or per-user basis. World wide web based discussion groups (i.e., also known as clubs) have also provided a way for groups of people to associate around a topic. Through the use of web server programming, the idea of discussion groups and discussion threads has been extended to provide users with the ability to subscribe to secured discussion forums that are, in some cases, moderated by other users.

Another variant of Internet based communication forums are the web-based “social network” applications, in which a number of users are able to find each others' accounts and voluntarily become “friends” or “followers” of each other's posted messages. Users generally post brief messages about their status, mood, activities, and such, and their friends and followers can read and optionally reply to those messages. As such, friends may stay abreast of each other's' activities as a tool for maintaining their social bonds.

### SUMMARY

In general, innovative aspects of the subject matter described in this disclosure may be embodied in methods that include the actions of receiving, from a first author user, a first post data set associated with a first post in a social networking service, the first post data set including first distribution data, the first distribution data indicating one or more recipient users to which the first post is to be distributed, determining that at least one recipient user of the one or more recipient users is a non-direct intended recipient, the non-direct intended recipient not being a contact of the first author user within the social networking service, receiving a first social affinity score, the first social affinity score indicating a strength of a relationship between the first author user and the non-direct intended recipient, determining that the first post is to be distributed to the non-direct intended recipient at least partially based on the first social affinity score, and distributing the first post to the non-direct intended recipient.

Other implementations of this aspect include corresponding systems, apparatus, and computer programs, configured to perform the actions of the methods, encoded on computer storage devices.

These and other implementations may each optionally include one or more of the following features. For instance, distributing the first post to the non-direct intended recipient includes transmitting digital content associated with the first post for display to the non-direct intended recipient, such that the digital content is displayed within an incoming stream page; actions further include: receiving user input from the non-direct intended recipient, the user input being associated with the first post, and in response to receiving the user input, establishing the author user and the non-direct intended recipient as direct contacts within the social networking service; the user input is generated in response to action of the non-direct intended recipient to a button icon that is displayed in association with the first post; the incoming stream page includes one or more posts that are distributed to the non-direct intended recipient from author users that are not contacts of the non-direct intended recipient within the social networking service; actions further include: determining that at least one recipient user is a direct intended recipient, the direct intended recipient being a contact of the first author user within the social networking service, and in response to determining that the at least one recipient user is a direct intended recipient, distributing the first post to the direct intended recipient; distributing the first post to the direct intended recipient includes transmitting digital content associated with the first post for display to the direct intended recipient, such that the digital content is displayed within a home stream page; the home stream page includes one or more posts that are distributed to the direct intended recipient from author users that are contacts of the direct intended recipient within the social networking service; actions further include: receiving, from a second author user, a second post data set associated with a second post in the social networking service, the second post data set including second distribution data, the second distribution data indicating one or more recipient users to which the second post is to be distributed, determining that the second distribution includes the non-direct intended recipient, the non-direct intended recipient not being a contact of the second author user within the social networking service, determining that the non-direct intended recipient has blocked the second author user from sending posts to the non-direct intended recipient using the social networking service, and refraining from distribution of the second post to the non-direct intended recipient; actions further include: receiving, from a second author user, a second post data set associated with a second post in the social networking service, the second post data set including second distribution data, the second distribution data indicating one or more recipient users to which the second post is to be distributed, determining that the second distribution includes the non-direct intended recipient, the non-direct intended recipient not being a contact of the second author user within the social networking service, determining that digital content associated with the post is spam, and refraining from distribution of the second post to the non-direct intended recipient; actions further include: receiving, from a second author user, a second post data set associated with a second post in the social networking service, the second post data set including second distribution data, the second distribution data indicating one or more recipient users to which the second post is to be distributed, determining that the second distribution includes the non-direct intended recipient, the non-direct intended recipient not being a contact of the second author user within the social networking service, receiving a second social affinity score, the second social affinity score indicating a strength of a relationship between the second author user and the non-direct intended recipient, determining that the second post is not to be distributed to the non-direct intended recipient at least partially based on the second social affinity score, and refraining from distribution of the second post to the non-direct intended recipient; determining that the first post is to be distributed to the non-direct intended recipient at least partially based on the first social affinity score includes determining that the first social affinity score is greater than a threshold score; actions further include, in response to determining that the first post is to be distributed to the non-direct intended recipient, transmitting instructions to display an indication that a post has been distributed to the non-direct intended recipient from the first author user; actions further include: receiving first user input from the non-direct intended recipient, and in response to the first user input, displaying an incoming stream page, the incoming stream page including the first post; the first user input is provided based on interaction with the indication; the indication is displayed within a home stream page associated with the non-direct intended recipient; and determining that the first post is to be distributed to the non-direct intended recipient is further based on determining that the first author user has not been blocked by the non-direct intended recipient and determining that the first post is not spam

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an example network architecture.

FIG. 2 is a diagram of an example social network including social circles.

FIGS. 3A and 3B depict screen-shots of example graphical user interfaces for creating and maintaining social circles.

FIG. 4 is a flowchart of an example process that can be executed in implementations of the present disclosure.

FIG. 5A depicts a screen-shot of an example stream page for a user of a social networking service.

FIG. 5B depicts a screen-shot of an example incoming stream page for a user of a social networking service.

FIG. 6 depicts a graphical representation of an example process to determine whether a post is to be distributed to an intended recipient.

FIG. 7 is a flowchart of an example process that can be executed in implementations of the present disclosure.

Like reference numbers represent corresponding parts throughout.

### DETAILED DESCRIPTION

### 1. Introduction

In general, implementations of the present disclosure are directed to enabling distribution of digital content within computer-implemented social networking services from an author user to one or more recipient users, when the author user and the one or more recipient users have not yet established one another as direct contacts in a social networking service. In this manner, users of the social networking service are able to receive digital content (e.g., posts) from other users that have not yet been established as contacts within the social networking service. Based on the received digital content and other factors, the user receiving the digital content can determine whether to add the user that distributed the digital content as a contact within the social networking service. In this manner, relationships between users of the social networking service can be promoted without the use of explicit invites or requests from one user to another.

### 2. Example Social Networking Services

For purposes of illustration, an example social networking service will be described. The example social networking service enables users to organize contacts into social groupings referred to as social circles. It is appreciated, however, that implementations of the present disclosure can be used in other types of social networking services and are not limited to social networking services that include social circles.

In general, social circles are categories to which a user can assign contacts and better control the distribution and visibility of social networking posts and/or other digital content distributed using the social networking service. In some implementations, a social circle can be provided as a data set defining a collection of contacts that are associated with one another in a computer-implemented social networking service. Generally, a social circle can be described from the perspective of an individual that is the center of a particular collection of socially interconnected people, or from the aggregate perspective of a collection of socially interconnected people. A social circle can have narrowly defined boundaries (e.g., members of the social circle might be familiar with one another) and permission may be required for a member to join a social circle. A user of the social networking service can define a social circle. The social circle, as a data set defining a collection of contacts, may reflect real-life social connections and/or interactions of the user. In some implementations, a social circle can be defined by a user as a personal representation or grouping of a set of contacts, the contacts may be unaware of the social circle and/or unaware of other members of the social circle.

Through the creation and use of social circles, the user can organize and categorize social networking contacts into various different groupings that can be used to control the visibility and access those contacts have to the user's postings, digital pictures, videos, audio files, hyperlinks (e.g., uniform resource indicators, URIs), and/or other content associated with the user's social networking profile. As one example, the user can post an update about a work-related nuance to only a “coworker” circle, and spare other contacts within the social networking service from seeing information that is irrelevant to them.

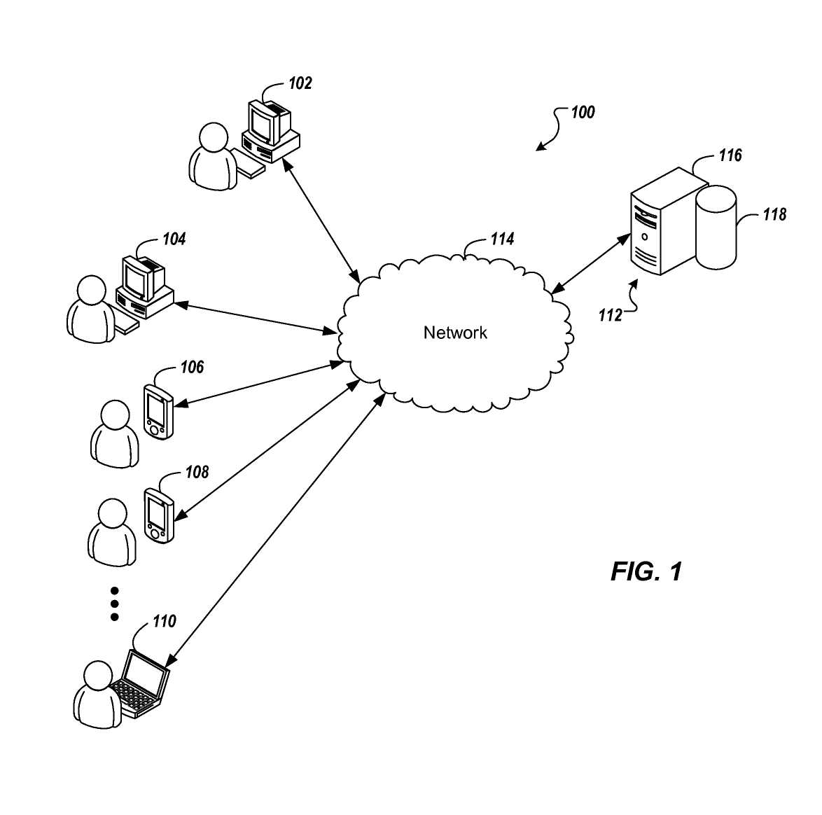

FIG. 1 is a diagram of an example network architecture 100. The network architecture 100 includes a number of client devices 102-110 communicably connected to a server system 112 by a network 114. The server system 112 includes a processing device 116 and a data store 118. The processing device 116 executes computer instructions (e.g., social network computer program code, and/or IM computer program code) stored in the data store 118 to perform the functions of a social network server and/or IM server.

Users of the client devices 102-110 access the server device 112 to participate in a social networking service. For example, the client devices 102-110 can execute web browser applications that can be used to access the social networking service and/or an IM service. In another example, the client devices 102-110 can execute software applications that are specific to the social networking service and/or the IM service (e.g., social networking and/or IM “apps” running on smartphones).

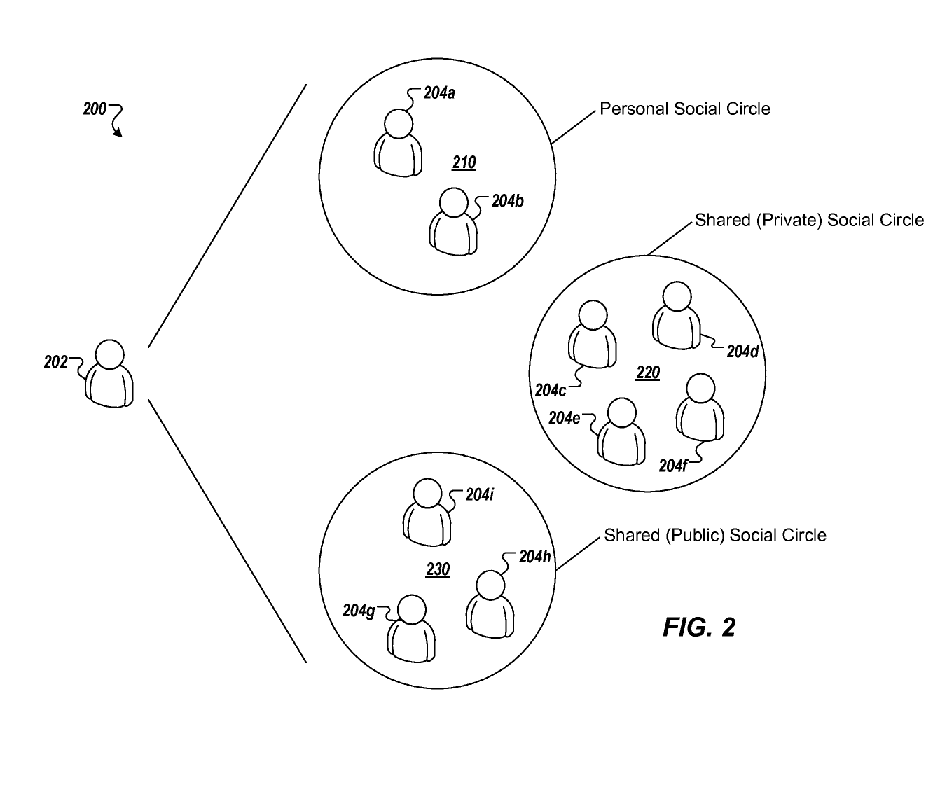

Users interacting with the client devices 102-110 can participate in the social networking service provided by the server system 112 by digital content, such as text comments (e.g., updates, announcements, replies), digital images, videos, audio files, and/or other appropriate digital content. In some implementations, information can be posted on a user's behalf by systems and/or services external to the social networking service or the server system 112. For example, the user may post a review of a movie to a movie review website, and with proper permissions that website may cross-post the review to the social networking service on the user's behalf. In another example, a software application executing on a mobile device, with proper permissions, may use global positioning system (GPS) capabilities to determine the user's location and automatically update the social network with his location (e.g., “At Home”, “At Work”, “In Brownsdale, MN”). Generally, users interacting with the client device 102-110 can also use the social networking service provided by the server system 112 to define social circles to organize and categorize the user's relationships to other users of the social networking service. Examples of the creation and use of social circles are provided in the description of FIG. 2.

In some implementations, the client devices 102-110 can be provided as computing devices such as laptop or desktop computers, smartphones, personal digital assistants, portable media players, tablet computers, televisions with one or more processors embedded therein and/or coupled thereto, or other appropriate computing devices that can be used to communicate with an electronic social network. In some implementations, the server system 112 can be a single computing device such as a computer server. In some implementations, the server system 112 can represent more than one computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

FIG. 2 is a diagram of an example social network 200 including social circles. A user 202 is a member of a social network that supports the creation and use of social circles (e.g., the social network provided by the server device 112 of FIG. 1). In the present example, the user 202 has a number of contacts 204a-204i with which the user 202 can have some form of relationship (e.g., friends, coworkers, customers, teammates, clients, relatives, club members, classmates). The user 202 categorizes the contacts 204a-204i by assigning them to one or more social circles, such as a social circle 210, a social circle 220, and a social circle 230. A social circle 240, which has a number of contacts 242a-242c, is provided as a query-based social circle that can be automatically generated without input from the user 202. In some implementations, the social circle 240 can be generated based on information gathered from and has some commonality among the user 202 and the users 242a-242c (e.g., posts, uploaded photos, check-ins, volunteered location information).

The social circle 210 is a personal circle. In some implementations, personal circles are groupings created by and may be known only to the user 202 (e.g., the contacts 204a, 204b may receive no indication that they are in the user's 202 personal social circle 210). In some implementations, personal social circles are groupings created by the user 202 and may be known to the user 202 as well as the contacts (e.g., contacts 204a, 204b) that are members of the social circle (e.g., the contacts 204a, 204b receive an indication that they have been added to the personal social circle 210).

In some implementations, personal circles may be used to organize and categorize the contacts 204a-204i in ways that are relevant to the user 202. In some implementations, the user 202 may use personal social circles to organize contacts in order to discretely target which of his contacts 204a-204i will see certain postings or have access to particular information. For example, the user 202 may be planning a surprise party for a small group of friends. As such, the user can organize contacts into “Surprise Party Attendees” and “Surprise Party Honorees” personal circles. By doing so, the user 202 may better target selected postings to the friends attending and/or helping to plan the surprise party (i.e., Surprise Party Attendees), while targeting selected postings to friends that are to be honored at the surprise party (i.e., Surprise Party Honorees) to maintain the integrity of the surprise.

The social circle 220 is a shared private circle, which may also be referred to simply as a shared circle. In general, shared private circles are social circles that the user 202 creates and invites contacts to voluntarily join. Contacts that accept the invitation become members of the shared private circle. Members of a shared private circle can see information posted to that circle by the user 202 and can post information to be shared with other members of the shared private circle. For example, the user 202 may tend to post a large number of jokes to the social network. However, while some of the contacts 204a-204i may find the jokes to be entertaining, others may find them to be simply annoying. Realizing this, the user 202 may create a “jokes” shared private circle and invite some or all of the contacts 204a-204i to join. With the “jokes” social circle in place, the user 202 may post witticisms to the “jokes” circle, and only those contacts who have accepted the invitation are able to see the comicality of the user 202. Similarly, members of the shared private circle are able to post messages to the circle, and those posts are visible to other members of that circle.

The social circle 230 is a shared public circle. In general, shared public circles are social circles that the user 202 creates, and invites contacts to voluntarily join. Further, the existence of a shared public circle is publicly available such that other users of the social networking service (e.g., not necessarily just the user's 202 contacts 204a-204i) may request to join the public social circle. Members of shared public circles may post information to, and see updates posted by, other members of the same public shared circle. In some implementations, public shares circles may be “fan” or “group” circles (e.g., circles dedicated to a particular place, event, product, movie, celebrity, sports team, company, concept, philosophy, organization, support network). For example, the user 202 may create a shared public circle for his band, and fans of his act may join the circle to discuss upcoming shows, download MP3s of the band's music, or post videos from recent concerts. In another example, the user 202 may create a shared public circle for alumni of his high school graduating class, which his former classmates may find and join in order to stay in touch with one another and post pictures from their school days. Once a shared public circle is created, in some implementations the user 202 can invite people to join the circle. In some implementations, nonmembers of the circle can request membership in the shared public circle, and membership in a shared public circle may be automatic upon request, or may require the user's 202 approval to become members of the shared public circle.

A given contact may be placed in several of the user's 202 social circles. For instance, a single contact may be a friend and coworker of the user 202, fan of the user's 202 jokes, a follower of the user's 202 band, and a surprise party attendee. The single contact therefore may be present in several of the user's 202 social circles, including multiple private and public circles.

In some implementations, one or more default social circles can be provided or suggested to a user when the user subscribes to a social networking service. For example, “Friends,” “Family,” and “Coworkers” social circles can automatically be provided in a user's profile upon the user subscribing to the particular social networking service. Other social circles can automatically be provided including, for example, an “Acquaintances” social circle and/or a “Just Following” social circle. In some implementations, the automatically created or suggested social circles can include personal social circles. Although default social circles can be automatically provided, it may be left to the user to actually populate the default social circles with contacts. For example, each of the default social circles may initially be empty of contacts, and the user populates each of the default social circles as discussed in further detail herein.

As discussed herein, digital content can be distributed to contacts within the social networking service including one or more social circles, such that they are exclusively viewable by the indicated contacts and/or contacts within one or more indicated social circles. For example, a user of the social networking service can generate a post and indicate one or more social circles for distribution of the post. In some implementations, an auto-complete component enables the user to type in part of the name of a social circle and/or individual contact to specify which social circles and/or individual contacts require delivery of the post content. During a post write-time, a post data set is transmitted from the user's client computing device (e.g., client device 102 of FIG. 1) to a distribution hub, which can be provided at a server (e.g., server system 112 of FIG. 1). The post data set includes a plurality of data. In some implementations, the post data set includes post content data (e.g., text, uniform resource indicator (URI)), timestamp data (e.g., a timestamp indicating the time that the post was generated), distribution data (e.g., contacts and/or one or more social circles), and identification (ID) data (e.g., an ID assigned to the post data set upon generation of the post).

In some implementations, and as discussed in further detail herein, other data can be appended to post data sets. Example other data can be spam indication data and scoring data. In some examples, spam indication data can be appended to a post data set to indicate that the post data set is considered to be spam. In some examples, spam can include unsolicited bulk messages. In some examples, scoring data can include a social affinity score among other possible scoring data.

In some implementations, the scoring data can be recipient specific. In some examples, the scoring data can include social affinity data that is provided based on respective social affinity scores between an author of the post and each recipient of the post. For example, a first user can author a post and define a distribution of the post, creating an underlying post data set. The distribution can include a second user and a third user. A first social affinity score associated with a social relationship between the first user and the second user can be provided, and a second social affinity score associated with a social relationship between the first user and the third user can be provided. The first social affinity score can be different from the second social affinity score, reflecting different social relationships between the first user and the second user and the first user and the third use. The first social affinity score and the second social affinity score can be appended to the post data set and/or stored in another location while maintaining an association with the post data set.

In some implementations, the distribution data is processed to provide an access control list (ACL) that specifies which contacts within the social networking system are granted access to the post content. In some implementations, social affinity scores can also be processed to provide the ACL. For example, the distribution data can indicate that the post content is to be accessible by and/or distributed to a particular user. A social affinity score can be determined for the post and can be specific to a relationship between the particular user and the author of the post. In some examples, if the social affinity score is below a threshold score, it is determined that the post content will not be accessible by and/or distributed to the particular user. Consequently, although the particular user had been explicitly targeted for distribution of the post by the author, the particular user is not provided in the ACL for the post. In some examples, if the social affinity score is at or above the threshold score, it is determined that the post content will be accessible by and/or distributed to the particular user. Consequently, the particular user had been explicitly targeted for distribution of the post by the author and the particular user is provided in the ACL for the post.

Generally, the distribution hub determines end points the post data set is to be distributed to based on the ACL. More specifically, the set of contacts that may care about the post and/or that are allowed access to the post is determined based on the ACL, and the ID of the post is written to a per user/view index at the distribution hub. When fetching posts to distribute to a user, the user/view index is accessed and the IDs of the various posts that the user is allowed to view are determined. The post data sets are retrieved from a data store (e.g., data store 118 of FIG. 1) and are transmitted to a client device associated with the requesting user. In some implementations, and as discussed in further detail herein, the ACL can be provided based on the overall score, the quality score and/or the social affinity score.

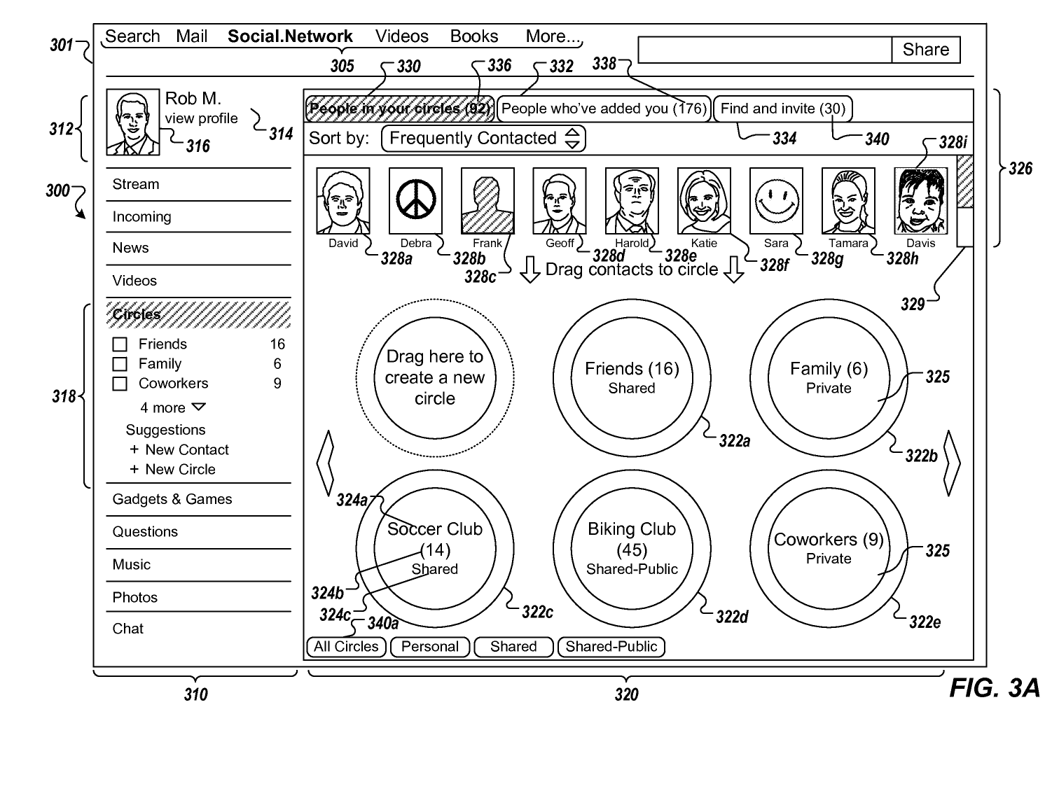

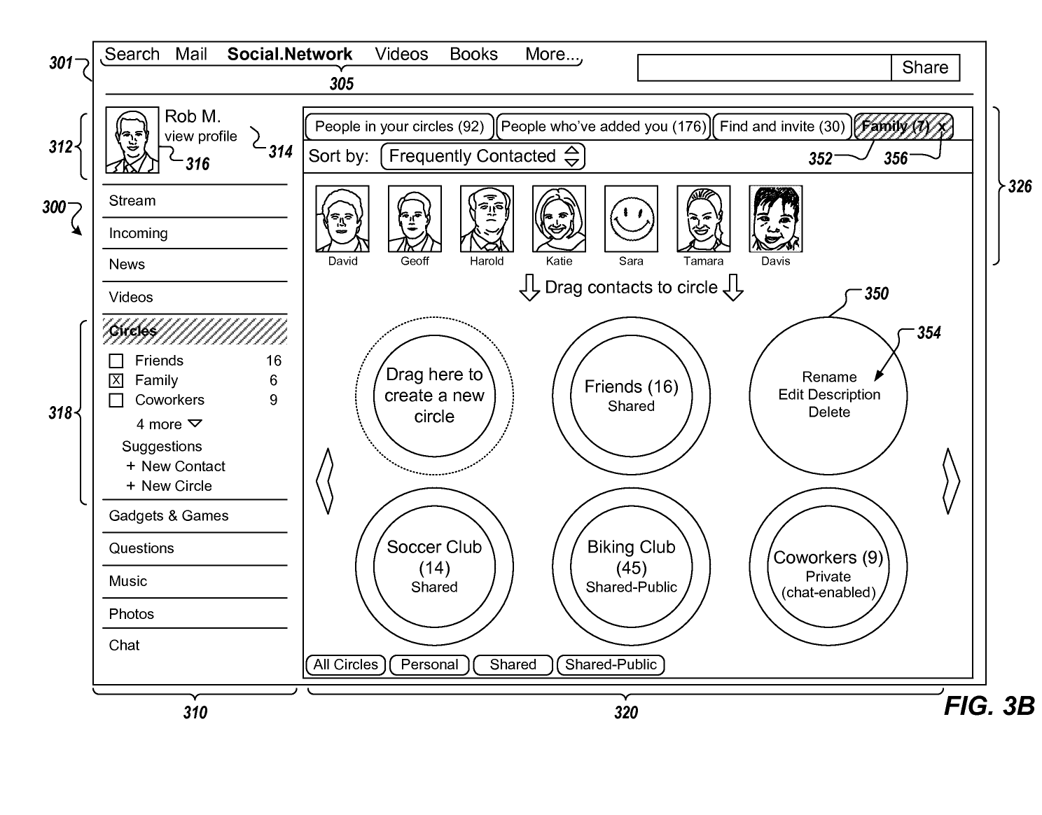

FIGS. 3A and 3B depict screen-shots 300 of example graphical user interfaces for creating and maintaining social circles. In the screen-shot 300, a social graph editor user interface (UI) 301 is shown. In some implementations, the UI 301 can be the interface presented by a purpose made social networking application, while in some implementations the UI 301 can be one or more web pages of a social networking website displayed in a general purpose web browser.

In the example of FIG. 3A, the UI 301 includes a number of choices presented in a menu bar 305. In the present example, the “Social Network” choice has been selected by a user. This selection causes a web-based social networking application to be executed and a social network menu 310 to be displayed. The social network menu 310 includes a profile indicator 312 in which information such as a user name 314 and a user image 316 associated with the currently logged in user are displayed.

The social network menu 310 also displays, among other items, a social circles sub-menu 318. The social circles sub-menu 318, when selected (e.g., as represented by the highlighting of the submenu's title), causes a social circle display 320 to be presented. The social circle display 320 includes a number of circles 322a-322e that are visual representations of various social circles that the user has created or has permission to edit. Each of the circles 322a-322e displays information about the social circle it represents. For example, the circle 322c displays a name 324a, a count 324b of the number of contacts associated with the social circle, and an indication 324c of what kind of circle (e.g., personal, private shared, public shared) that the circle 322c is.

The social circle display 320 also includes a contact display 326. The contact display 326 provides a graphical interface for viewing, selecting, and organizing items in the user's contact lists. A collection of contact icons 328a-328i represents the contacts or other entities (e.g., organizations, places, or other items) socially networked with the particular user. In some implementations, the icons can be digital photos of the contacts they represent (e.g., the icons 328a, 328d), arbitrary images (e.g., the icons 328b, 328g), or placeholders (e.g., when the contact has no image associated with their account, such as the icon 328c). In some implementations, the icons can include additional information, such as the names of each contact. A scroll bar 329 is provided for the user to view additional contact icons that may not fit into the initial view.

In the example of FIG. 3A, the social circle display 320 includes tabs 330, 332, 334. The tabs 330, 332, 334 can be provided as visual extensions of the social circle display 320. As discussed herein, each tab can be activated (e.g., clicked on) by the user to filter content displayed within the social circle display. The tab 330 is associated with all contacts that are in social circles of the logged in user (“Rob M.” in this example) and can include a count 336 indicating a number of contacts that the user has in social circles. In the depicted example, the tab 330 is selected. Consequently, the contact display 326 displays all contacts of the user that are members of one or more social circles of the user. In some examples, all of the user's contacts within the social networking service are each associated with one or more social circles. Consequently, when the tab 330 is selected, all of the user's contacts within the social networking service are displayed in the contact display 326.

The tab 332 is associated with other users of the social networking service that have added the particular user (“Rob M.” in this example) to one or more social circles and can include a count 338 indicating a number of other users of the social networking service that have added the user to social circles. As discussed in further detail herein, a user of the social networking service that is not a direct contact of the particular user (“Rob M.” in this example) can still add the particular user to one or more social circles in an effort to establish a direct relationship to the particular user, as discussed in further detail herein. Consequently, the count 338 of the tab 332 can include a number of users that is greater than the count 336 of the tab 330. In response to user selection of the tab 332, other users of the social networking service that have added the particular user to social circles are displayed in the contact display 326. In this manner, the particular user is afforded an opportunity to review the other users and to initiate a reciprocal social networking relationship with one or more of the other users (i.e., establish one or more of the other users as a direct contact within the social networking service).

The tab 334 is associated with other users of the social networking service that can be suggested to the particular user (“Rob M.” in this example) for inclusion in one or more social circles of the user and can include a count 340. In response to user selection of the tab 334, other users of the social networking service that are suggested contacts for the particular user are displayed in the contact display 326. In this manner, the particular user is afforded an opportunity to review the suggested and to initiate a social networking relationship with one or more of the suggested contacts (i.e., send an introductory post).

In some implementations, a social circle can be selected to generate a tab corresponding to the social circle. For example, user input can be received to the social circle display 320, which user input can indicate a user command to generate a tab corresponding to the social circle. Example user input can include a user double-clicking on the graphical representation of a social circle or clicking on and dragging the social circle to the area of the social circle display 320 where the tabs 330, 332, 334 are provided. In some implementations, and in response to receiving the user input, the graphical representation of the social circle can change, a tab corresponding to the selected social circle can be generated and can be displayed adjacent to the tabs 330, 332, 334, and the contacts displayed in the contact display 326 can be revised to only include those contacts that are members of the selected social circle.

Referring now to FIGS. 3A and 3B, an example selection of a social circle and resultant generation of a tab will be described. A user interacting with the social circle display 320 can select the family social circle 322b. For example, the user can double-click on the family social circle 322b or click on and drag the family social circle 322b to the area of the social circle display 320 where the tabs 330, 332, 334 are provided. With particular reference to FIG. 3B, and in response to the user input, the graphical representation of the family social circle can change to a placeholder, or shadow graphical representation 350, a tab 352 corresponding to the family social circle can be displayed, and the contacts displayed in the contact display 326 can be revised to only include those contacts that are members of the selected social circle. The graphical representation 350 can include a menu 354 including user-selectable options relating to the social circle. Example options can include a rename option to rename the social circle, an edit description option to edit a description of the social circle and a delete option to delete the social circle. The tab 352 can include an action item 356 that can be activated (e.g., clicked on) by the user.

Through generation and selection of tabs, a filter is effectively applied to filter which contacts are displayed in the contact display 326. For example, and with reference to FIG. 3A, selection of the tab 330 results in all of the contacts of the user (“Rob M.” in this example) being displayed in the contact display 326. In the depicted example, the number of contacts that are displayable in the contact display 326 is ninety-two (92). With reference to FIG. 3B, selection of the tab 350 results in only the contacts of the user (“Rob M.” in this example) that are members of the family social circle being displayed in the contact display 326. In the depicted example, the number of contacts that are displayable in the contact display 326 is seven (7).

Using the tabs, and creating new tabs based on social circles (e.g., the tab 352), enables the user to more efficiently manage contacts and/or the generation and population of new social circles. For example, if a user would like to create a new social circle to include contacts that would be a subset of contacts of an existing social circle, it is more efficient for the user to search through a filtered list of contacts than all contacts to select contacts to add to the new social circle. This is discussed in further detail below by way of example.

Continuing with the example above, the user (“Rob M.” in this example) might like to create and populate a siblings social circle, a brothers social circle and a sisters social circle. Instead of searching through all contacts (e.g., as would be displayed in the contact display 326 if the tab 330 is selected), the user can generate a tab corresponding to a family social circle (i.e., the tab 352), as discussed above. In this manner, and by selecting the tab 352, only contacts of the family social circle are displayed, which contacts are presumably family members. Consequently, the user is presented with a truncated list of contacts (as compared to a list of all contacts) to select from for adding to the new social circles. In the depicted example, the user can quickly select the contacts “David,” “Geoff,” “Katie” and “Tamara” to add to the new siblings social circle, select the contacts “David” and “Geoff” to add to the new brothers social circle, and select the contacts “Katie” and “Tamara” to add to the new sisters social circle.

If the user activates the action item 356, the tab 352 is removed and the graphical representation of the social circle 322b is re-displayed (e.g., as depicted in FIG. 3A). Also, in response to user activation of the action item 356, the contacts that are displayed in the contact display 326 change to include contacts associated with a remaining tab (e.g., the tabs 330, 332, 334). For example, contacts associated with the tab 330 are displayed in the contact display 326.

### 3. Incoming Digital Content

As introduced above, implementations of the present disclosure are directed to enabling distribution of digital content within computer-implemented social networking services from an author user to one or more recipient users, when the author user and the one or more recipient users have not yet established one another as direct contacts in a social networking service. In this manner, users of the social networking service are able to receive digital content (e.g., posts) from other users that have not yet been established as contacts within the social networking service. Based on the received digital content and other factors, the user receiving the digital content can determine whether to add the user that distributed the digital content as a contact within the social networking service. In this manner, relationships between users of the social networking service can be promoted without the use of explicit invites or requests from one user to another.

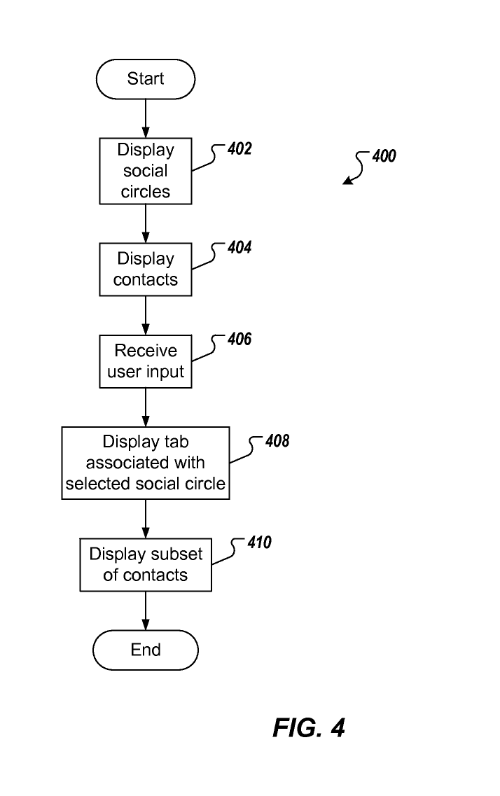

FIG. 4 is a flowchart of an example process 400 that can be executed in implementations of the present disclosure. In some implementations, the example process 400 can include operations that are performed using one or more computer programs executed using one or more data processing apparatus (e.g., one or more client-side computing devices and/or one or more server-side computing devices). In some examples, one or more server computing devices can perform server-side operations that can include serving one or more web page documents to a client computing device operated by a user, each document containing instructions for a browser application to perform client-side operations.

Graphical representations of one or more social circles established by a user within a social networking service are displayed (402). For example, and with reference to FIG. 3A, graphical representations of the social circles 322a-322e are displayed. Graphical representations of contacts of the user within the social networking service are displayed (404), the graphical representations of the contacts being displayed in a contact display. For example, and with reference to FIG. 3A, graphical representations of the contacts 328a-328i are displayed in the contact display 326.

User input associated with a social circle of the one or more social circles is received (406). For example, and with reference to FIG. 3A, a user can double click on, or click and drag, the graphical representation of the family social circle 322b. In response to the user input, a tab associated with the social circle is displayed (408), and graphical representations of a subset of contacts are displayed within the contact display (410), the first subset of contacts including contacts that are associated with the social circle. For example, and with reference to FIG. 3B, the tab 352 associated with the family social circle is displayed, and graphical representations of contacts of the family social circle are displayed within the contact display 326.

Implementations of the present disclosure enables users to receive posts from other users of the social networking service that are not direct contacts of the user. In some implementations, a user (referred to herein as the author user) can generate a post (e.g., including digital content) and can define a distribution of the post, as discussed herein. The distribution can include one or more other users that are not direct contacts of the user within the social networking service. For example, the distribution can include a first user and a second user, with neither the first user nor the second user being a direct contact of the author user. That is, the author user is not within a social circle of the first user or the second user in the context of the social networking service, or is otherwise not a contact of the author user within the social networking service. As discussed in further detail herein, data associated with the post can be analyzed to determine whether the post is to be distributed to the first user and/or the second user. If it is determined that the post is to be distributed to at least one of the first user and the second user, the post appears in respective incoming streams of the first and second users, as discussed in further detail herein.

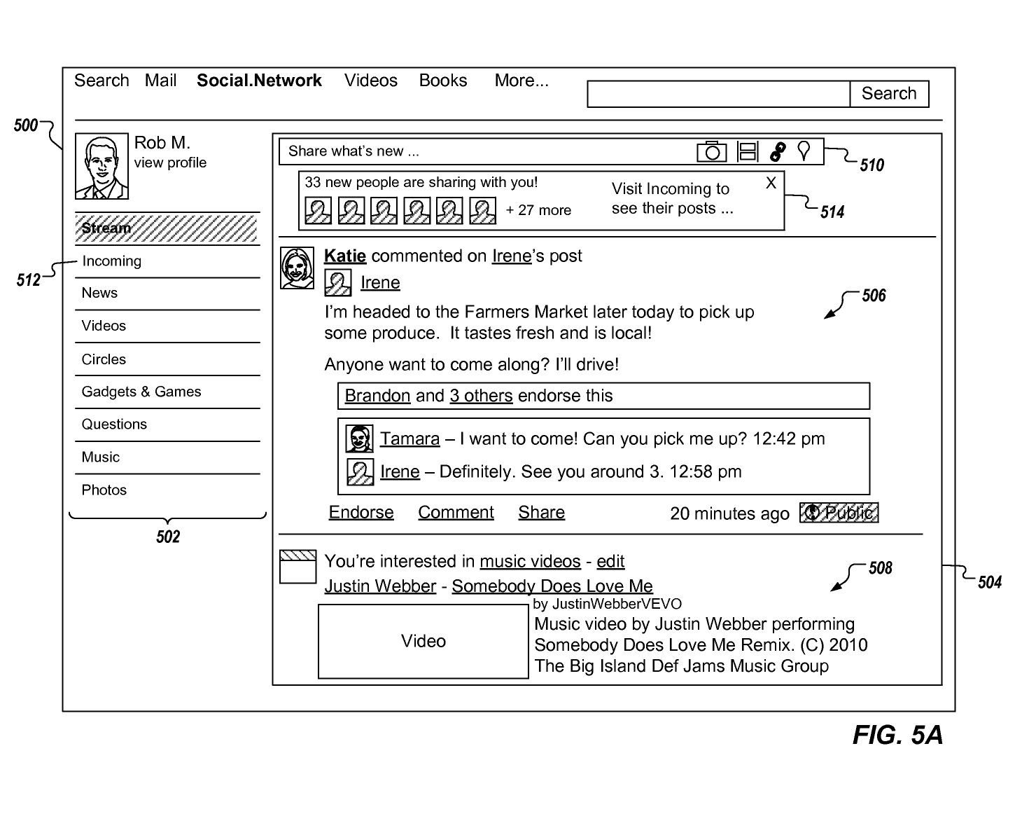

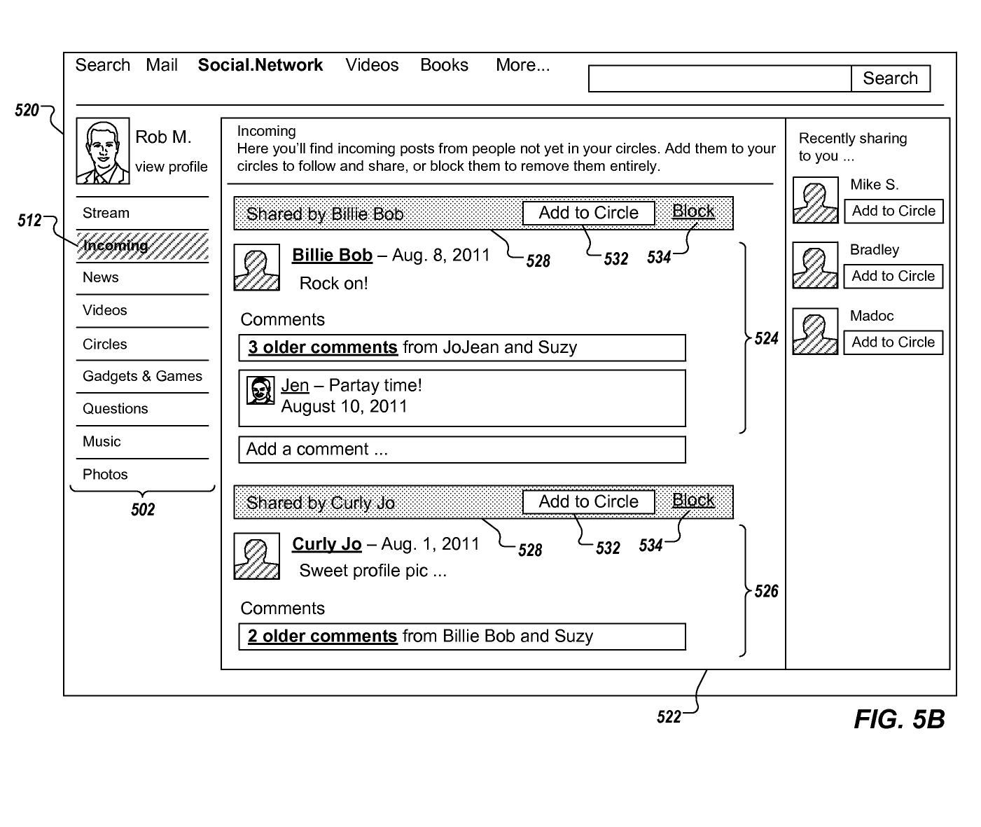

As discussed in further detail herein, determination of whether a post from a non-direct contact of a user is to be distributed to the user can be determined based on data associated with the post. Example data can include a social affinity score, among other scores. Distribution and reception of posts from a user of the social networking service to other users that are not direct contacts of the user will be discussed in further detail herein by way of example with reference to FIGS. 5A and 5B.

FIG. 5A depicts a screen-shot of an example stream page 500 for a user of a social networking service. For example, the stream page 500 can be provided as a web page within a website of a social networking service, and can display digital content that has been shared with a user associated with the stream page 500. In the illustrated example, the example user includes “Rob M.” and the stream page 500 displays digital content that other users have shared with the user and/or digital content that the user has shared with other users. The stream page 500 includes a social network menu 502 and a post region 504. Example digital content 506, 508 that has been distributed to the user is displayed in the post region 504. Generally, the digital content 506, 508 displayed in the post region 504 is digital content that is distributed to the user from direct contacts established within the social networking service. A content sharing interface 510 can also be provided in the post region 504. Although the content sharing interface 510 is displayed on the stream page 500 in the illustrated example, it is appreciated that the content sharing interface 510 can be displayed on particular web pages or all web pages of the social networking service. In this manner, the content sharing interface 510 can be available to the user on any web page and the user is not required to go to a particular web page to share digital content. The user can activate (e.g., click on) the content sharing interface 510 to share digital content.

In accordance with implementations of the present disclosure, and as discussed in further detail with reference to FIG. 5B, an incoming stream page can be provided. In some examples, a menu item 512 corresponding to the incoming stream page can be selected to display incoming stream posts in the post region 504, as discussed in further detail herein. In some implementations, a dialog box 514 can be displayed within the post region 504 to alert the user to new users that are sharing digital content with the user, and can instruct the user to visit the user's incoming stream page to view the shared digital content.

FIG. 5B depicts a screen-shot of an example incoming stream page 520 for the user of the social networking service. The example incoming stream page 520 includes the social network menu 502 and a post region 522. Example digital content 524, 526 that has been distributed to the user is displayed in the post region 522. Generally, the digital content 524, 526 displayed in the post region 522 is digital content that is distributed to the user from contacts that have not yet been established as direct contacts within the social networking service. In the depicted example, respective headers 528, 530 can be associated with the digital content 524, 526. The headers 528, 530 can indicate the author of the digital content (i.e., the author user that distributed the digital content), an action item 532 for adding the author of the digital content to a social circle and an action item 534 for blocking the author from distributing digital content to the user in the future. In the depicted example, the action item 532 is provided as a button that can be selected by the user to trigger a process for adding the author to one or more social circle of the user, thereby establishing the author as a direct contact of the user within the context of the social networking service. In the depicted example, the action item 534 is provided as user-selectable hypertext that can be selected by the user to block the author from distributing digital content to the user in the future.

As discussed in detail herein, a post can be generated by an author user (i.e., an author of the post) and the author user can define a distribution for the post, the distribution including one or more users of the social networking service. The author user can submit the post for distribution to the one or more contacts to generate a post data set and to initiate a post write-time process. During the post write-time, a post data set is transmitted from the user's client computing device (e.g., client device 102 of FIG. 1) to a distribution hub, which can be provided at a server (e.g., server system 112 of FIG. 1). In some examples, and as discussed above, the post data set can include post content data (i.e., digital content), timestamp data, distribution data and ID.

In some implementations, the distribution data can include one or more target users (referred to as intended recipients), to which the author intends the post to be distributed. The one or more intended recipients can include an intended recipient that has not yet been established as a direct contact of the author in the social networking service (referred to as a non-direct intended recipient). That is, for example, the non-direct intended recipient can include a user of the social networking service that has not added the author to one or more social circles used by the non-direct intended recipient in the social networking service (i.e., a reciprocal contact relationship between the author and the intended recipient has not been established). The post data set can be processed and can be distributed, or otherwise made available to intended recipients that have already been established as direct contacts of the author within the social networking service. As discussed in further detail herein, the post data can be processed to determine whether the post will indeed be distributed to the non-direct intended recipient. If it is determined that the post is to be distributed to the non-direct intended recipient, the post is displayed in the incoming stream associated with the non-direct intended recipient. In some implementations, the distribution data is processed to provide an ACL that specifies to which contacts within the social networking system a particular post is to be distributed. In some implementations, the ACL includes direct intended recipients (i.e., direct contacts of the user within the social networking service that are identified in the distribution of the post) and non-direct intended recipients. In some embodiments, distribution to non-direct recipients may only be performed by the system if the user has been provided notice and/or have assented to such distribution.

As discussed in further detail herein, whether a post is to be distributed to a non-direct intended recipient can be determined at least partially based on a social affinity score. In some implementations, the social affinity score can be determined on a per user relationship basis. In some examples, the affinity score can be determined based on a social affinity between the author and the non-direct intended recipient in view of a social graph of the non-direct intended recipient. A social graph can be provided as a plurality of nodes with edges between nodes. Each node of the plurality of nodes represents a user, and each edge between nodes represents a relationship between the nodes. Each edge (i.e., each relationship) may be accompanied by a social affinity score that can be provided as a number that identifies a strength of the relationship. Continuing with the example above, the author can be represented as a first node and the non-direct intended recipient can be represented as a second node.

The affinity score can be provided by an affinity scoring module that processes the social graphs of users to determine the strengths of relationships therebetween. The strength of a relationship can be determined based on how socially connected users are. For example, if the first user and the second user are direct contacts within the social networking service, the associated social vicinity score between the first and second users can be higher than if the first user is a direct contact of a direct contact of the second user (e.g., a friend of a friend).

In some examples, a first user and a second user are direct contacts, and the first user and a third user are also direct contacts. A fourth user can be a direct contact of the second user. A fifth user can be a direct contact of the second user and a direct contact of the third user. A social affinity score between the first user and the fifth user can be higher than a social affinity score between the first user and the fourth user, because the first user is a direct contact of a direct contact of the fifth user (e.g., a friend of a friend) through both the second user and the third user, and is only a direct contact of a direct contact of the fourth user (e.g., a friend of a friend) through the second user.

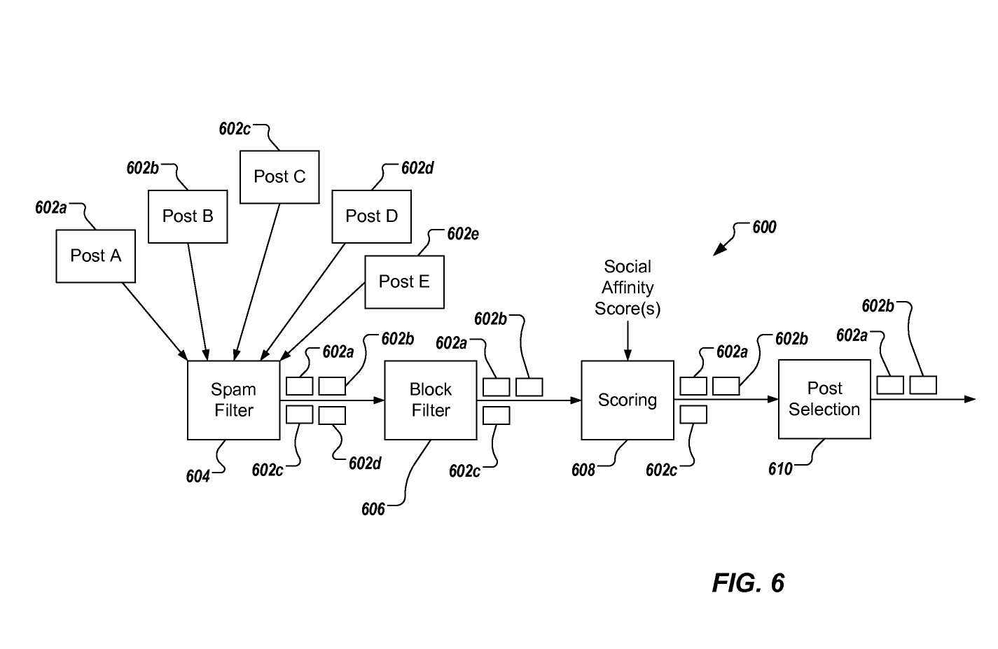

FIG. 6 depicts a graphical representation of an example process 600 to determine whether a post is to be distributed to an intended recipient. The example process 600 is discussed in the context of five example posts 602a-602e that are to be distributed to a non-direct intended recipient. The posts 602a-602e can be processed using a spam filter module 604, a block filter module 606, a score module 608 and a post selection module 610. In some examples, each of the spam filter module 604, the block filter module 606, the scoring module 608 and the post selection module 610 can be provided using one or more computer program applications executed using one or more computing devices. It is appreciated that the example posts 602a-602e can be processed on a post-by-post basis as they are generated and received. The score module 608 can receive social affinity scores from a social affinity score calculation service (not shown).

In the example of FIG. 6, the posts 602a-602e each have an associated distribution that includes a non-direct intended recipient in view of the respective authors of the post. The post 602a can be authored by a user of the social networking service that is a friend of a friend of the non-direct intended recipient within the social networking service, and is considered to be a high quality post. The post 602b can be authored by a user that has no social relationship with the non-direct intended recipient within the social networking service, or otherwise, and is considered to be a high quality post. The post 602c can be authored by a user that has a no social relationship with the non-direct intended recipient within the social networking service, or otherwise, and is considered to be a low quality post. The post 602d can be authored by a user that the non-direct intended recipient has already blocked, and the post 602e can be considered to be spam.

When the post data set of the post 602a is received at the distribution hub, the post 602a can be processed to determine whether the post is spam using the spam filter module 604. In the instant example, it is determined that the post 602a is not spam. Consequently, the post 602a is provided to the block filter module 606. In the instant example, it is determined that the author of the post 602a has not been blocked by the non-direct intended recipient. Consequently, the post 602a is provided to the scoring module 608.

The score module 608 can receive a social affinity score that indicates a strength of a relationship between the author of the post 602a and the non-direct intended recipient. In some implementations, the score module 608 can append the social affinity score to the post 602a. The post 602a with score data is provided to the post selection module 610. The post selection module 610 can process the score data to determine whether to distribute the post 602a to the non-direct intended recipient. In the instant example, the post selection module 610 can determine that the social affinity score is greater than a threshold score. Consequently, the post 602a is distributed to the non-direct intended recipient, and the post 602a will be displayed in the incoming stream page of the non-direct intended recipient.

When the post data set of the post 602b is received at the distribution hub, the post 602b can be processed through the spam filter module 604, the block filter module 606 and the score module 608, as similarly discussed above with respect to the post 602a. The post 602b with score data is provided to the post selection module 610. The post selection module 610 can process the score data to determine whether to distribute the post 602b to the non-direct intended recipient. In the instant example, the post selection module 610 can determine that the social affinity score is greater than the threshold score. Consequently, the post 602b is distributed to the non-direct intended recipient, and the post 602b will be displayed in the incoming stream page of the non-direct intended recipient.

When the post data set of the post 602c is received at the distribution hub, the post 602c can be processed through the spam filter module 604, the block filter module 606 and the score module 608, as similarly discussed above with respect to the posts 602a, 602b. The post 602c with score data is provided to the post selection module 610. The post selection module 610 can process the score data to determine whether to distribute the post 602c to the non-direct intended recipient. In the instant example, the post selection module 610 can determine that the social affinity score is less than the threshold score. Consequently, the post 602c is not distributed to the non-direct intended recipient.

When the post data set of the post 602d is received at the distribution hub, the post 602d can be processed through the spam filter module 604, as similarly described above with respect to the posts 602a, 602b, 602c and can be provided to the block filter module 606. The block filter module 606 can process the post 602d and determine that the author of the post 602d has been blocked by the non-direct intended recipient. Consequently, the post 602d is not distributed to the non-direct intended recipient.

When the post data set of the post 602e is received at the distribution hub, the post 602e can be processed by the spam filter module 604. The spam filter module 604 can process the post 602e and determine that the post 602e is spam. Consequently, the post 602e is not distributed to the non-direct intended recipient. In some examples, whether a post is spam can be determined based on matching the author and/or content of the post to known spam authors and/or spam content. In some examples, whether a post is spam can be determined based on social affinity scores between the author of the post and each of the number of intended recipients provided in the associated distribution. For example, if the number of intended recipients exceeds a threshold number of recipients and the author has little to no social affinity to the intended recipients, the post can be deemed to be spam.

It is appreciated that the example processes discussed herein can be at least partially performed on a per-user basis. Continuing with the example of FIG. 6, the author of the post 602d can define a distribution of the post 602d that can include a first non-direct intended recipient and a second non-direct intended recipient. The first non-direct intended recipient may have previously blocked the author. Consequently, the post 602d is filtered for distribution to the first non-direct intended recipient (e.g., using the block filter 604, as discussed above). The second non-direct intended recipient did not previously block the author. Consequently, the post 602d passes through the block filter 604 for continued processing to determine whether the post 602d will be distributed to the second non-direct intended recipient, as similarly discussed above with respect to the posts 602a-602c.

In another example, the author of the post 602c can define a distribution of the post 602c that can include a first non-direct intended recipient and a second non-direct intended recipient. Using the scoring module, first social affinity score data that is specific to a relationship between the author and the first non-direct intended recipient can be associated with the post 602c, and second social affinity score data that is specific to a relationship between the author and the second non-direct intended recipient can be associated with the post 602c. The post selection module 610 can process the post 602c based on at least the first social affinity score data and the second social affinity score data and can determine that the post 602c is to be distributed to the first non-direct intended recipient, and that the post 602c is not to be distributed to the second non-direct intended recipient (e.g., the first non-direct intended recipient is a friend of a friend of the author, while the second non-direct intended recipient has no relationship with the author).

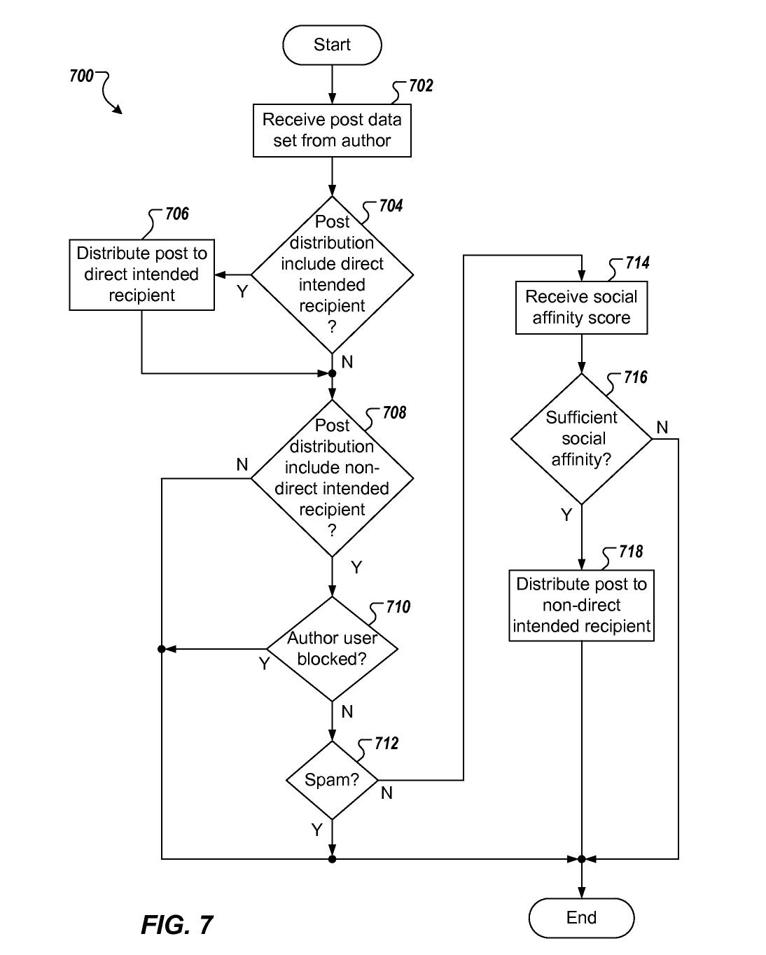

FIG. 7 is a flowchart of an example process 700 that can be executed in implementations of the present disclosure. In some implementations, the example process 700 can include operations that are performed using one or more computer programs executed using one or more data processing apparatus (e.g., one or more client-side computing devices and/or one or more server-side computing devices).

A post data set is received from an author user (702). As discussed above, the post data set includes a distribution indicating one or more intended recipients for an underlying post. It is determined whether the distribution includes one or more direct intended recipients (704). As discussed herein, a direct intended recipient can include a user of a social networking service that has been established as a direct contact of the author user within the social networking service. If it is determined that the distribution includes one or more direct intended recipients, the post is distributed to each of the one or more direct intended recipients (706), as discussed herein.

It is determined whether the distribution includes a non-direct intended recipient (708). As discussed herein, a non-direct intended recipient can include a user of a social networking service that has not been established as a direct contact of the author user within the social networking service. If it is determined that the distribution does not include a non-direct intended recipient, the example process 700 can end. If it is determined that the distribution includes a non-direct intended recipient, it is determined whether the non-direct intended recipient has blocked the author user (710). For example, an index associated with the non-direct intended recipient can be accessed. The index can include a list of users that the non-direct intended recipient has blocked. If the non-direct intended recipient has blocked the author user, the system refrains from distributing the post to the non-direct intended recipient and the example process 700 ends.

If the non-direct intended recipient has not blocked the author user, it is determined whether the post is spam (712). If the post is spam, the system refrains from distributing the post to the non-direct intended recipient and the example process 700 ends. If the post is not spam, a social affinity score is received (714). As discussed herein, the social affinity score can indicate a strength of a relationship between the author user and the non-direct intended recipient within the social networking service. It is determined whether a social affinity between the author user and the non-direct intended recipient is sufficient to distribute the post to the non-direct intended recipient (716). In some examples, the social affinity score can be compared to a threshold score. If the social affinity score is less than the threshold score, the social affinity between the author user and the non-direct intended recipient is insufficient to distribute the post to the non-direct intended recipient. Consequently, the system refrains from distributing the post to the non-direct intended recipient and the example process 700 ends. If the social affinity score is greater than or equal the threshold score, the social affinity between the author user and the non-direct intended recipient is sufficient to distribute the post to the non-direct intended recipient. Consequently, the post is distributed to the non-direct intended recipient (718) and the example process 700 ends.

It is appreciated that at least actions 710-718 can be repeated for each non-direct intended recipient, when a plurality of non-direct intended recipients are provided in the distribution.

### 4. Additional Implementations

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be realized in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet. Actions as described herein may be carried out on a distributed system, a multiprocessor system, and/or one or more virtual machines operating over a distributed architecture such as cloud.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

What is claimed is:

1. A system comprising:
one or more computing devices; and
one or more computer-readable media coupled to the one or more computing devices and having instructions stored thereon which, when executed by the one or more computing devices, cause the one or more computing devices to perform operations comprising:
receiving, from a first author user, a first post data set associated with a first post in a social networking service, the first post data set comprising first distribution data, the first distribution data indicating a plurality of recipient users to which the first post is to be distributed;
distributing the first post to at least one direct intended recipient of the plurality of recipient users, the direct intended recipient being a contact of the first author user within the social networking service;
determining that at least one recipient user of the a plurality of recipient users is a non-direct intended recipient, the non-direct intended recipient not being a contact of the first author user within the social networking service;
receiving a first social affinity score, the first social affinity score indicating a strength of a relationship between the first author user and the non-direct intended recipient;
determining that the first affinity score meets a threshold score;
distributing the first post to the non-direct intended recipient at least partially in response to determining that the first social affinity score meets the threshold score.

2. The system of claim 1, wherein operations further comprise:
providing for display to the non-direct intended recipient, an interface for adding the first author user as a contact;
receiving input from the non-direct intended recipient, the input indicating that the first author user is to be added as a new contact of the non-direct intended recipient; and
in response to receiving the input, identifying the first author user as the new contact of the non-direct intended recipient within the social networking service.

3. The system of claim 1, wherein determining that the first post is to be distributed to the non-direct intended recipient at least partially based on the first social affinity score comprises determining that the first social affinity score is greater than a threshold score.

4. The system of claim 1, wherein distributing the first post to the non-direct intended recipient comprises transmitting digital content associated with the first post for display to the non-direct intended recipient, such that the digital content is displayed within an incoming stream page.

5. The system of claim 4, wherein operations further comprise:
receiving user input from the non-direct intended recipient, the user input being associated with the first post; and
in response to receiving the user input, establishing the author user and the non-direct intended recipient as direct contacts within the social networking service.

6. The system of claim 5, wherein the user input is generated in response to action of the non-direct intended recipient to a button icon that is displayed in association with the first post.

7. The system of claim 4, wherein the incoming stream page comprises one or more posts that are distributed to the non-direct intended recipient from author users that are not contacts of the non-direct intended recipient within the social networking service.

8. The system of claim 1, wherein operations further comprise:
receiving, from a second author user, a second post data set associated with a second post in the social networking service, the second post data set comprising second distribution data, the second distribution data indicating one or more recipient users to which the second post is to be distributed;
determining that the second distribution includes the non-direct intended recipient, the non-direct intended recipient not being a contact of the second author user within the social networking service;
determining that the non-direct intended recipient has blocked the second author user from sending posts to the non-direct intended recipient using the social networking service; and
refraining from distribution of the second post to the non-direct intended recipient.

9. The system of claim 1, wherein operations further comprise:
receiving, from a second author user, a second post data set associated with a second post in the social networking service, the second post data set comprising second distribution data, the second distribution data indicating one or more recipient users to which the second post is to be distributed;
determining that the second distribution includes the non-direct intended recipient, the non-direct intended recipient not being a contact of the second author user within the social networking service;
determining that digital content associated with the post is spam; and
refraining from distribution of the second post to the non-direct intended recipient.

10. The system of claim 1, wherein operations further comprise:
receiving, from a second author user, a second post data set associated with a second post in the social networking service, the second post data set comprising second distribution data, the second distribution data indicating one or more recipient users to which the second post is to be distributed;
determining that the second distribution includes the non-direct intended recipient, the non-direct intended recipient not being a contact of the second author user within the social networking service;
receiving a second social affinity score, the second social affinity score indicating a strength of a relationship between the second author user and the non-direct intended recipient;
determining that the second post is not to be distributed to the non-direct intended recipient at least partially based on the second social affinity score; and
refraining from distribution of the second post to the non-direct intended recipient.

11. The system of claim 1, wherein determining that the first post is to be distributed to the non-direct intended recipient is further based on determining that the first author user has not been blocked by the non-direct intended recipient and determining that the first post is not spam.

12. A non-transitory computer-readable medium storing one or more computer-executable programs, wherein the one or more computer-executable programs comprise instructions that, when executed by a data processing apparatus, cause the data processing apparatus to perform operations comprising:
receiving, from a first author user, a first post data set associated with a first post in a social networking service, the first post data set comprising first distribution data, the first distribution data indicating a plurality of recipient users to which the first post is to be distributed;
distributing the first post to at least one direct intended recipient of the plurality of recipient users, the direct intended recipient being a contact of the first author user within the social networking service;
determining that at least one recipient user of the a plurality of recipient users is a non-direct intended recipient, the non-direct intended recipient not being a contact of the first author user within the social networking service;
receiving a first social affinity score, the first social affinity score indicating a strength of a relationship between the first author user and the non-direct intended recipient;
determining that the first affinity score meets a threshold score;
and
distributing the first post to the non-direct intended recipient at least partially in response to determining that the first social affinity score meets the threshold score.

13. The media non-transitory computer-readable medium of claim 12, wherein operations further comprise, in response to determining that the first post is to be distributed to the non-direct intended recipient, transmitting instructions to display an indication that a post has been distributed to the non-direct intended recipient from the first author user.

14. The media non-transitory-computer readable medium of claim 13, wherein operations comprise:
receiving first user input from the non-direct intended recipient; and
in response to the first user input, displaying an incoming stream page, the incoming stream page including the first post.

15. The media non-transitory computer-readable medium of claim 14, wherein the first user input is provided based on interaction with the indication.

16. The media non-transitory computer-readable medium of claim 13, wherein the indication is displayed within a home stream page associated with the non-direct intended recipient.

17. A computer-implemented method comprising:
receiving, using one or more computing devices, from a first author user, a first post data set associated with a first post in a social networking service, the first post data set comprising first distribution data, the first distribution data indicating a plurality of recipient users to which the first post is to be distributed;
distributing, using the one or computing devices, the first post to at least one direct intended recipient of the plurality of recipient users, the direct intended recipient being a contact of the first author user within the social networking service;
determining, using the one or more computing devices, that at least one recipient user of the a plurality of recipient users is a non-direct intended recipient, the non-direct intended recipient not being a contact of the first author user within the social networking service;
receiving, using the one or more computing devices, a first social affinity score, the first social affinity score indicating a strength of a relationship between the first author user and the non-direct intended recipient;
determining, using the one or more computing devices, that the first affinity score meets a threshold score;
and
distributing, using the one or more computing devices, the first post to the non-direct intended recipient at least partially in response to determining that the first social affinity score meets the threshold score.

18. The method of claim 17, wherein operations further comprise:
determining that at least one recipient user is a direct intended recipient, the direct intended recipient being a contact of the first author user within the social networking service; and
in response to determining that the at least one recipient user is a direct intended recipient, distributing the first post to the direct intended recipient.

19. The method of claim 18, wherein distributing the first post to the direct intended recipient comprises transmitting digital content associated with the first post for display to the direct intended recipient, such that the digital content is displayed within a home stream page.

20. The method of claim 19, wherein the home stream page comprises one or more posts that are distributed to the direct intended recipient from author users that are contacts of the direct intended recipient within the social networking service.
